(19) United States
(12) Patent Application Publication
(10) Pub. No.: US 2026/0340528 A1
(43) Pub. Date: Oct. 29, 2026

(54) MEASURE PLANNING SUPPORT APPARATUS, MEASURE PLANNING SUPPORT METHOD, AND NON-TRANSITORY COMPUTER-READABLE MEDIUM

(71) Applicant: NEC Corporation, Tokyo (JP)

(72) Inventors: Miku YANAGIMOTO, Tokyo (JP); Yukikazu Yamaoka, Tokyo (JP); Kei Sato, Tokyo (JP)

(73) Assignee: NEC Corporation, Tokyo (JP)

(21) Appl. No.: 19/533,447

(22) Filed: Feb. 9, 2026

(30) Foreign Application Priority Data
Mar. 19, 2025 (JP) 2025-045708

(51) Int. Cl. G06Q 10/0631

(52) U.S. Cl. CPC G06Q 10/06311

(57) ABSTRACT

A measure planning support apparatus includes a measure acquisition unit for acquiring one or more measures that can be introduced into a user facility, and a priority determination unit for determining priority of the one or more measures based on at least a part of facility information that is information regarding the user facility, case information regarding introduction results of past measures, and public information.

### INCORPORATION BY REFERENCE

This application is based upon and claims the benefit of priority from Japanese patent application No. 2025-045708, filed on Mar. 19, 2025, the disclosure of which is incorporated herein in its entirety by reference.

### TECHNICAL FIELD

The present disclosure relates to a measure planning support apparatus, a measure planning support method, and a non-transitory computer-readable medium.

### BACKGROUND ART

As a related art, JP 2023-184760 A discloses an information processing system that appropriately specifies an organizational problem. The information processing system described in JP 2023-184760 A acquires organization information of an organization A. The information processing system specifies another organization similar to the state of the organization A based on the acquired organization information. The information processing system specifies the organizational problem of the organization A based on the organizational problem specified in another organization. The information processing system proposes the specified organizational problem to the organization A.

In JP 2023-184760 A, the information processing system can determine an improvement method in the organization A, that is, an improvement action for the specified organizational problem. For example, the information processing system determines an improvement method related to the specified problem by using correspondence information in which each problem and the improvement method are associated with each other. The information processing system can propose an improvement method to the organization A together with an organizational problem to be improved.

### SUMMARY

In a business operator having a distribution center, a delivery center, or the like, a manager such as a center manager desires to optimize in-warehouse business processes and improve employee satisfaction, but consideration of problems, and resources necessary for execution, that is, a human, time, knowledge, and technology are insufficient. Upon taking in new measures, the process from consideration to introduction is long. The solution by a consultant takes time, and the knowledge is biased.

In JP 2023-184760 A, the information processing system can specify an organizational problem of an organization A and propose an improvement action for the specified organizational problem. However, the proposed improvement actions may include actions that are not effective in the organization A. The manager of the organization A needs to consider which action among a plurality of proposed improvement actions is effective in the organization A.

An example object of the present disclosure is to provide a measure planning support apparatus, a measure planning support method, and a program capable of shortening the time required for considering measures to be introduced in planning of measures.

A measure planning support apparatus according to a first example aspect of the present disclosure includes a measure acquisition unit for acquiring one or more measures that can be introduced into a user facility, and a priority determination unit for determining priority of the one or more measures based on at least a part of facility information that is information regarding the user facility, case information regarding introduction results of past measures, and public information.

A measure planning support method according to a second example aspect of the present disclosure includes acquiring one or more measures that can be introduced into a user facility, and determining priority of the one or more measures based on at least a part of facility information that is information regarding the user facility, case information regarding introduction results of past measures, and public information.

A program according to a third example aspect of the present disclosure causes a computer to execute processing of acquiring one or more measures that can be introduced into a user facility, and determining priority of the one or more measures based on at least a part of facility information that is information regarding the user facility, case information regarding introduction results of past measures, and public information.

The measure planning support apparatus, the measure planning support method, and the program according to the present disclosure can shorten a time required for considering measures to be introduced in planning of measures.

### BRIEF DESCRIPTION OF THE DRAWINGS

The above and other aspects, features and advantages of the present disclosure will become more apparent from the following description of certain exemplary embodiments, taken in conjunction with the accompanying drawings, in which:

FIG. 1 is a block diagram illustrating a configuration example of a measure planning support apparatus according to the present disclosure;

FIG. 2 is a diagram illustrating a specific example of measures to be acquired;

FIG. 3 is a diagram illustrating specific examples of measures and priorities presented to a user;

FIG. 4 is a flowchart illustrating an operation procedure of the measure planning support apparatus; and

FIG. 5 is a block diagram illustrating a configuration example of a computer device.

### EXAMPLE EMBODIMENT

Hereinafter, an example embodiment of the present disclosure will be described in detail with reference to the drawings. In the drawings, the same or related elements are denoted by the same reference numerals, and repeated description is omitted as necessary for clarity of description.

FIG. 1 is a block diagram illustrating a configuration example of a measure planning support apparatus according to the present disclosure. An example embodiment will be described with reference to FIG. 1. A measure planning support apparatus 100 illustrated in FIG. 1 includes a measure acquisition unit 101 and a priority determination unit 102. The measure planning support apparatus 100 is configured as, for example, a device including one or more memories and one or more processors. At least some of the functions of the measure planning support apparatus 100 can be implemented by the processor executing processing according to a command read from the memory.

In the following example embodiment, an example in which the measure planning support apparatus 100 is applied to a business operator of a retail business, a manufacturing business, or a warehouse business having a facility such as a distribution center or a delivery center will be described. The measure planning support apparatus 100 can be used for the purpose of proposing a measure capable of optimizing the in-warehouse business processes or a measure capable of improving the employee satisfaction. The measure planning support apparatus 100 can be used, for example, to present a measure for at least partially solving a problem in the user's facility, that is, a solution to the user. In the present disclosure, the term “measure” and the term “solution” may be used as terms having the same meaning.

The measure acquisition unit 101 acquires one or more measures having a possibility of being introduced into the user's facility. Here, the measure having a possibility of being introduced into the user facility can mean, for example, a candidate of the measure considered to be introduced into the user facility. For example, a user such as a center manager who makes a decision on an approach in a facility inputs a problem in the facility or what the user wants to achieve in the facility to the measure acquisition unit 101. The measure acquisition unit 101 acquires a general solution to the input problem as a measure having a possibility of being introduced into the user's facility.

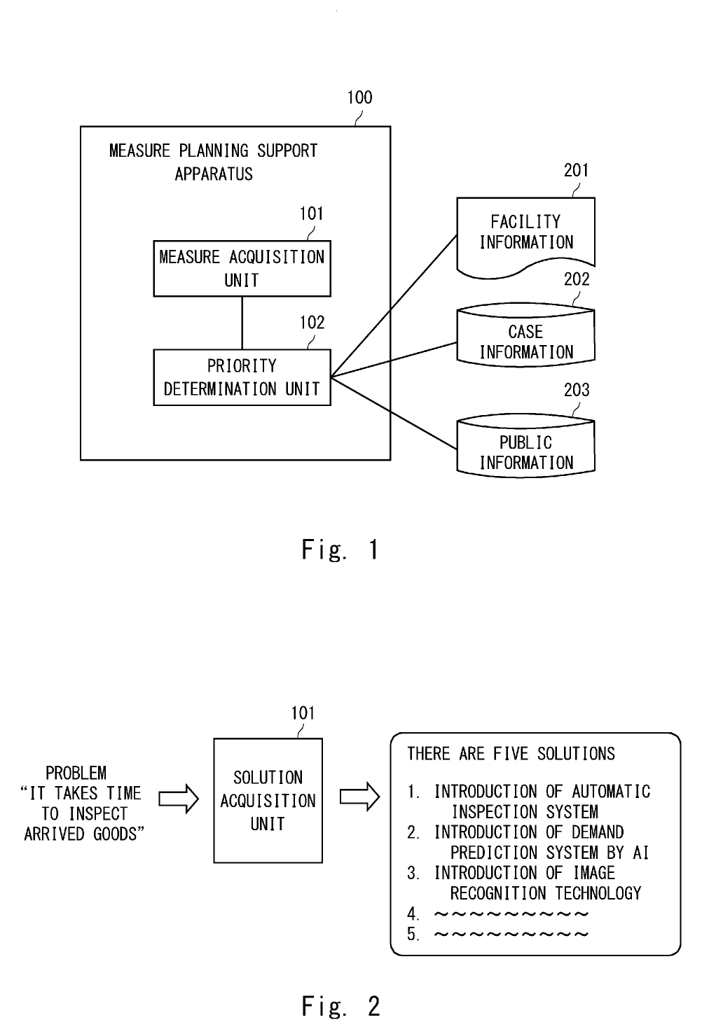

FIG. 2 is a diagram illustrating a specific example of measures to be acquired. For example, the user inputs a problem such as “it takes time to inspect arrived goods” to the measure acquisition unit 101. The measure acquisition unit 101 generates or acquires a general solution to the input problem. The measure acquisition unit 101 stores, for example, information in which a keyword related to a problem and a solution are associated with each other. The measure acquisition unit 101 may extract some keywords from the input problem and acquire solutions related to the extracted keywords.

The measure acquisition unit 101 may acquire a solution to the problem using an external service. For example, the measure acquisition unit 101 may transmit a problem to an external server and acquire a general measure having a possibility of being introduced with respect to the problem from the external server as a solution. The solutions acquired by the measure acquisition unit 101 may be generated by, for example, Artificial Intelligence (AI) using Large Language Models (LLM). In the example of FIG. 2, the measure acquisition unit 101 acquires five solutions as general solutions to the problem.

The facility information 201 includes information regarding a user facility such as a distribution center or a delivery center. The facility information 201 includes, for example, information regarding the design and scale of the center, information regarding an available product, information regarding a physical geographical condition, and information regarding an introduced system. The information regarding the design and size of the center includes, for example, an area, a height, an age of a building, a floor specification, number of working people, attributes of working person, and a communication environment. The attributes of the working person include, for example, gender, age, and family structure. The information regarding the available product includes a type and a storage amount of the product. The information regarding the physical geographical conditions includes the location, the surrounding transportation infrastructure, and the climatic conditions.

The case information 202 includes case information, that is, information regarding introduction results of measures in the past. The introduction results include information for identifying a facility where measures have been introduced and one or more measures introduced into the facility. The introduction results are associated with information of the facility into which the measure has been introduced, including information similar to the facility information 201. The case information 202 includes information regarding a successful case, that is, a case where problems have been at least partially solved by introduction of measures. The case information 202 includes information regarding a failure case, that is, a case where measures have been introduced but the effect on solving the problem has been low. The case information 202 can store case information of distribution centers and delivery centers of various industry types, and case information of facilities different from the distribution centers and the delivery centers.

Public information 203 includes information that is publicly available. The public information 203 includes, for example, information regarding measures that can be introduced into the facility. The information regarding measures may include, for example, information regarding the purpose, effect, cost, and effect for introducing the measures. The public information 203 can be acquired from, for example, a news article made public online. The public information 203 may include information related to weather of a place where the user facility is installed or a disaster risk degree.

The priority determination unit 102 determines the priority of each of one or more measures acquired by the measure acquisition unit 101 based on at least a part of the facility information 201, the case information 202, and the public information 203. The priority indicates, for example, at least one of effectiveness of each measure on the user facility and fitness of the measure to the user facility. The priority is represented by a plurality of levels such as “high”, “medium”, and “low”. The priority may be represented by a score value indicating the priority. The priority determination unit 102 does not need to determine the priority for all of the one or more measures acquired by the measure acquisition unit 101, and may determine the priority for some of the one or more measures.

For example, the priority determination unit 102 extracts introduction results in a facility similar to the user facility from the case information 202 based on the facility information 201, and determines the priority of each of the measures based on the extracted introduction results. The priority determination unit 102 may compare and analyze the facility information 201 and information of a facility into which measures have been introduced in the past in the case information 202, and determine the priority of each measure based on the result of the comparison and analysis. For example, the priority determination unit 102 analyzes the data of the successful case and the failure case in other facilities and the public information from some viewpoints, and integrates the analysis results to determine the priority. The priority determination unit 102 may determine the priority of each measure using an AI model learned to determine the priority of each measure from the facility information 201, the case information 202, and the public information 203.

For example, the priority determination unit 102 may decide the priority of each measure based on cost effectiveness in a case where each measure is introduced to the user facility to be a target of problem solving. For example, the priority determination unit 102 extracts a successful case and a failure case in a facility similar to the user facility from the case information 202. The priority determination unit 102 extracts, for example, a successful case and a failure case in a facility in which a scale of a facility, information regarding an available product, a physical geographical condition, and an introduced system are similar to those in a user facility. For example, the case information 202 includes information indicating whether the cost effectiveness is high in the successful case and the failure case. The priority determination unit 102 sets a high priority to a measure that is introduced in a successful case in a facility similar to the user facility and has high cost effectiveness. The priority determination unit 102 sets a low priority to a measure that is introduced in a failure case in a facility similar to the user facility or a measure having low cost effectiveness.

The cost effectiveness may be set for each measure. In addition, the cost effectiveness may be set according to the scale of the facility in which the measure is to be introduced. For example, for a certain measure, the cost effectiveness may be set to be high in a case where the measure is introduced into a large-scale facility, and the cost effectiveness may be set to be low in a case where the measure is introduced into a small-scale facility. In that case, the priority determination unit 102 may refer to the facility information 201 and determine the priority of each measure according to the scale of the user facility. In addition to or instead of cost effectiveness, the priority determination unit 102 may determine the priority of each measure based on the degree of cost reduction in a case where each measure is introduced into the user facility to be a target of problem solving.

For example, the priority determination unit 102 may determine the priority of each measure based on a period required for introducing each measure. For example, the case information 202 includes information regarding a period required for introducing a measure in the successful case. The priority determination unit 102 sets a high priority to a measure in which a period required for introduction is short in a successful case in a facility similar to the user facility. The priority determination unit 102 sets a low priority to a measure in which a period required for introduction is long in a successful case in a facility similar to the user facility. The period required for introduction may be set for each measure. The priority determination unit 102 may determine the priority of each measure according to the set period required for introduction.

The priority determination unit 102 may determine the priority of each measure based on the feasibility of the measure introduction to the user facility or the adaptability of each measure to the user facility. For example, each measure is associated with at least one of information for identifying a system that can be introduced and information for identifying a system that cannot be introduced. In that case, the priority determination unit 102 may determine that a measure that can be introduced into the system introduced into the user facility has a high suitability. The priority determination unit 102 may determine that a measure that cannot be introduced into the system introduced into the user facility has a low suitability. The priority determination unit 102 sets the priority of the measure having high suitability with the system introduced in the user facility to be high. The priority determination unit 102 sets the priority of the measure having low suitability with the system introduced in the user facility to be high.

The priority determination unit 102 may determine the priority of each measure based on the geographical conditions of the user facility. For example, each measure is associated with information regarding suitability or compatibility with the geographical conditions. As an example, the measure is associated with information regarding suitability or compatibility with the goodness of traffic access. For example, the priority determination unit 102 determines whether traffic access is good as a geographical condition of the user facility. For example, in a case where the user facility is installed in a place with good traffic access, the priority determination unit 102 sets the priority of a measure with a high introduction effect to be high in a case where the measure is introduced into a facility with good traffic access. In addition, the priority determination unit 102 sets the priority of a measure having a high introduction effect to be low in a case where the measure is introduced to a facility with poor traffic access.

The priority determination unit 102 may determine the priority of each measure based on the risk for a natural disaster. For example, the public information 203 includes information of a hazard map made public by the local government, and the priority determination unit 102 recognizes a risk of a natural disaster existing in the user facility from the hazard map. The priority determination unit 102 may determine the priority based on the suitability or compatibility between the risk of natural disaster and the measures. For example, in a case where the user facility is installed in a place where there is a lot of snow and the risk of occurrence of an avalanche is high, the measure of adding the outdoor facility to the user facility has low suitability to the user facility. The priority determination unit 102 may set a priority of a measure having a low suitability with a user facility installed in a place having a risk of natural disaster to be low.

The priority determination unit 102 may determine the priority of each measure based on the matching degree with the current goal of the user facility. For example, the facility information 201 includes a current goal in the user facility. The goal includes a business policy. Each measure is associated with information indicating suitability or compatibility with the business policy. As an example, the facility information 201 includes a business policy indicating business expansion as a current goal. In that case, the priority determination unit 102 determines the priority according to the suitability or compatibility between each measure and the business policy indicating business expansion. For example, the priority determination unit 102 sets a priority of a measure for reducing the business scale to be low.

The priority determination unit 102 may determine the priority of each measure based on the state of the employee in the user facility, for example, the stress level. For example, the facility information 201 includes a stress level of the employee in the user facility. Each measure is associated with a suitability or compatibility with the stress level of the employee. In a case where the stress level of the employee in the user facility is high, the measure for lowering the stress level of the employee has high suitability. Conversely, in a case where the stress level of the employee in the user facility is low, the measure for lowering the stress level of the employee has low suitability. In a case where the stress level of the employee is high, the priority determination unit 102 sets the priority of the measure for lowering the stress level to be high. In addition, in a case where the stress level of the employee is low, the priority determination unit 102 sets the priority of the measure for lowering the stress level to be low.

The priority determination unit 102 may extract a measure considered to be effective for the user facility from a plurality of measures acquired by the measure acquisition unit 101 and determine the priority for the extracted measure. As an example, the priority determination unit 102 may extract a measure included in a successful case in a facility similar to the user facility, a measure in which feasibility of introduction of the measure into the user facility is high, and a measure in which a matching degree with the current goal of the user facility is high as measures effective for the user facility. For example, the priority determination unit 102 may determine the priority for the extracted measure based on at least one of cost effectiveness, a period required to introduce the measure, a risk of natural disaster, and a state of an employee in the user facility.

The priority determination unit 102 may exclude a measure that is not suitable for introduction to the user facility from a plurality of measures acquired by the measure acquisition unit 101 from a target of priority determination, and determine the priority for the remaining measures without being excluded. As an example, the priority determination unit 102 may exclude a measure included in a failure case in a facility similar to the user facility, a measure in which feasibility of introduction of the measure into the user facility is low, and a measure in which a matching degree with the current goal of the user facility is low from the target of the priority determination. For example, the priority determination unit 102 may determine the priority for the remaining measures that are not excluded based on at least one of cost effectiveness, a period required to introduce the measures, a risk of natural disaster, and a state of an employee in the user facility.

In a case where there is insufficient information in the comparison and analysis, the priority determination unit 102 can request the user to input information. For example, the priority determination unit 102 holds, for each measure, information for identifying information to be analyzed in comparison and analysis, that is, information to be used for determination of the priority. For example, in a case where the facility information 201 does not include a part of the information to be used in the comparison and analysis, the priority determination unit 102 may urge the user to input additional information to be used in the comparison and analysis.

The priority determination unit 102 presents, to the user, one or more measures acquired by the measure acquisition unit 101, that is, at least some of the solutions and the priority. The priority determination unit 102 may present, to the user, a measure having high priority among the acquired one or more measures.

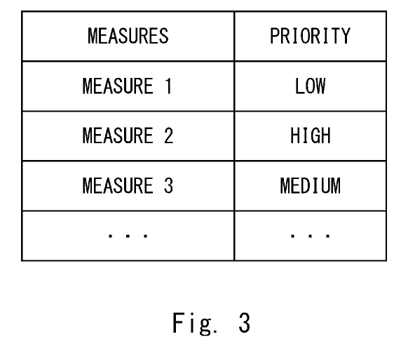

FIG. 3 is a diagram illustrating specific examples of measures and priorities presented to a user. In the example of FIG. 3, the measures acquired by the measure acquisition unit 101 include measure 1, measure 2, and measure 3. It is assumed that the priority determination unit 102 determines the priority “low” for the measure 1, determines the priority “high” for the measure 2, and determines the priority “medium” for the measure 3. The priority determination unit 102 presents each measure and its priority to the user.

The user can determine the measure 2 among the presented measures as a measure to be introduced to solve the problem in the user facility. After introducing the measure 2, the user can add information regarding introduction of the measure 2 to the case information 202. For example, in a case where the problem can be solved by introducing the measure 2, the user adds information regarding the introduction of the measure 2 as a successful case. Alternatively, in a case where the problem cannot be solved even by introducing the measure 2, the user adds information regarding introduction of the measure 2 as a failure case. The successful case or failure case added by the user can be used to determine the priority of the measure for the problem input by another user.

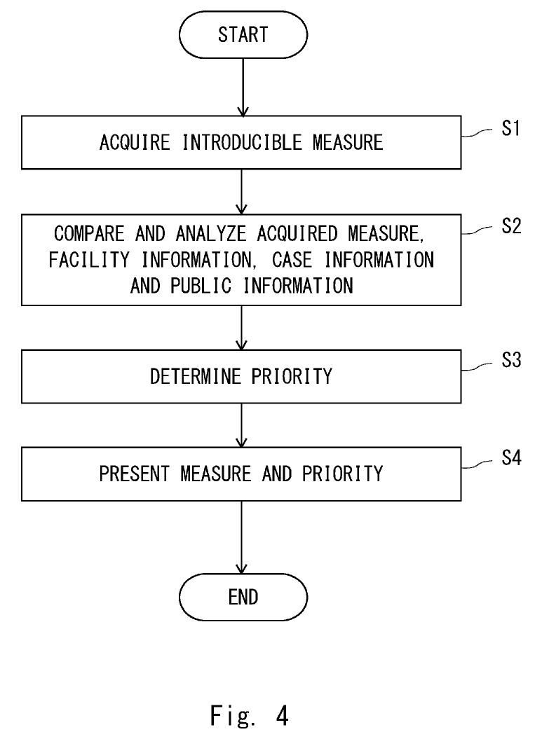

Next, an operation procedure will be described. FIG. 4 is a flowchart illustrating an operation procedure of the measure planning support apparatus 100. The operation procedure of the measure planning support apparatus 100 corresponds to the measure planning support method. The measure acquisition unit 101 acquires one or more measures that can be introduced into the user facility such as the delivery center (step S1). For example, in step S1, the measure acquisition unit 101 acquires one or more measures, that is, one or more solutions that can be introduced into the user facility for the input problem input by the user.

The priority determination unit 102 compares and analyzes the measures acquired in step S1, the facility information 201, the case information 202, and the public information 203 (step S2). The priority determination unit 102 determines the priority of the measures acquired in step S1 based on the result of the comparison and analysis (step S3). The priority determination unit 102 presents, to the user, the one or more measures acquired in step S1 and the priority determined in step S3 (step S4).

In one example embodiment, the measure acquisition unit 101 acquires one or more measures that can be introduced into the user facility. The priority determination unit 102 determines the priorities of the acquired one or more measures using the facility information 201, the case information 202, and the public information 203. For example, the priority determination unit 102 can extract a measure effective for the user facility from among a plurality of measures acquired by the measure acquisition unit 101 and determine priority for the extracted measure.

The priority determination unit 102 presents a measure that can be introduced into the user facility and its priority to the user. The user such as the facility manager can determine which measure is effective in the user facility with respect to the measures acquired by the measure acquisition unit 101 by referring to the priority. In one example embodiment, in planning a measure, a user can make a decision as to which measure to introduce for a problem without taking time for consideration. The user can concentrate resources on measures that are efficient and easy to achieve results. In one example embodiment, the measure planning support apparatus 100 can minimize the time and cost required to introduce the measure.

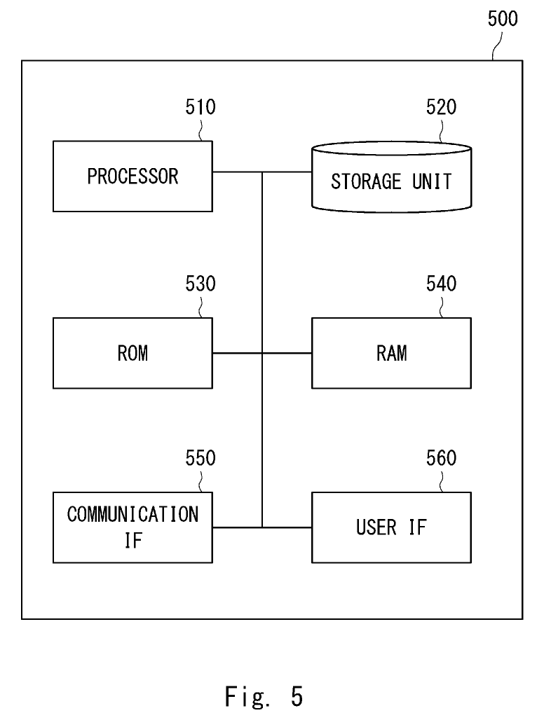

In the present disclosure, the measure planning support apparatus 100 can be configured using a computer device or a server device. FIG. 5 is a block diagram illustrating a configuration example of a computer device that can be used as the measure planning support apparatus 100. A computer device 500 includes a processor 510 such as a Central Processing Unit (CPU), a storage unit 520, a Read Only Memory (ROM) 530, a Random Access Memory (RAM) 540, a communication interface (IF) 550, and a user interface 560.

The communication interface 550 is an interface for connecting the computer device 500 to a communication network via wired communication means, wireless communication means, or the like. The user interface 560 includes, for example, a display unit such as a display. The user interface 560 includes input units such as a keyboard, a mouse, and a touch panel.

The storage unit 520 is an auxiliary storage device that can hold various types of data. The storage unit 520 does not necessarily need to be a part of the computer device 500 and may be an external storage device or a cloud storage connected to the computer device 500 via a network.

The ROM 530 is a nonvolatile storage device. For example, a semiconductor storage device such as a flash memory that has a relatively small capacity may be used for the ROM 530. A program executed by the processor 510 can be stored in the storage unit 520 or the ROM 530. The storage unit 520 or the ROM 530 stores, for example, various programs for implementing the functions of each unit of the measure planning support apparatus 100.

The program includes instructions (or software codes) for causing the computer to perform one or more functions described in the example embodiment in a case of being read by the computer. The program may be stored in a non-transitory computer-readable medium or in a tangible storage medium. As an example and not by way of limitation, the computer-readable medium or the tangible storage medium includes a RAM, a ROM, a flash memory, a solid-state drive (SSD) or any other memory technology, a Compact Disc (CD), a digital versatile disc (DVD), a Blu-ray (registered trademark) disc or any other optical disc storage, and a magnetic cassette, a magnetic tape, a magnetic disk storage, or any other magnetic storage device. The program may be transmitted on a transitory computer-readable medium or a communication medium. As an example and not by way of limitation, the transitory computer-readable medium or the communication medium includes electric, optical, acoustic, or any other form of propagation signals.

The RAM 540 is a volatile storage device. Various semiconductor memory devices such as a Dynamic Random Access Memory (DRAM) or a Static Random Access Memory (SRAM) are used for the RAM 540. The RAM 540 can be used as an internal buffer that temporarily stores data and the like. The processor 510 loads a program stored in the storage unit 520 or the ROM 530 into the RAM 540, and executes the program. The functions of each of the units in the measure planning support apparatus 100 can be implemented by the processor 510 executing the program. The processor 510 may include an internal buffer in which data and the like can be temporarily stored.

In the present disclosure, the measure planning support apparatus 100 does not necessarily need to be configured as a single computer device. The measure planning support apparatus 100 may be configured using a plurality of physically separated devices. The measure planning support apparatus 100 may be configured by, for example, a plurality of computer devices connected to each other via a network.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Each drawing is merely illustrative for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

Some or all of the above example embodiments may be described as the following Supplementary Notes, but are not limited to the following.

### Supplementary Note 1

A measure planning support apparatus including
a measure acquisition unit for acquiring one or more measures that can be introduced into a user facility, and
a priority determination unit for determining priority of the one or more measures based on at least a part of facility information that is information regarding the user facility, case information regarding introduction results of past measures, and public information.

### Supplementary Note 2

The measure planning support apparatus according to supplementary note 1, in which the measure acquisition unit acquires a measure for at least partially solving a problem in the user facility as the one or more measures.

### Supplementary Note 3

The measure planning support apparatus according to supplementary note 1 or 2, in which the priority determination unit extracts the introduction results in a facility similar to the user facility from the case information based on the facility information, and determines the priority of the one or more measures based on the extracted introduction results.

### Supplementary Note 4

The measure planning support apparatus according to any one of supplementary notes 1 to 3, in which the priority determination unit compares and analyzes the facility information and information of a facility into which measures have been introduced in the past in the case information, and determines the priority of the one or more measures based on a result of the comparison and analysis.

### Supplementary Note 5

The measure planning support apparatus according to any one of supplementary notes 1 to 4, in which the facility information includes information regarding a scale, an available product, a geographical condition, and an introduced system of the user facility.

### Supplementary Note 6

The measure planning support apparatus according to any one of supplementary notes 1 to 5, in which the priority determination unit determines the priority of the one or more measures based on at least one of cost effectiveness in a case where the measure is introduced into the user facility, a period required to introduce the measure, suitability of the measure to the user facility, a geographical condition of the user facility, a risk of natural disaster, a goal in the user facility, and a state of an employee in the user facility.

### Supplementary Note 7

The measure planning support apparatus according to any one of supplementary notes 1 to 6, in which the case information includes a successful case and a failure case.

### Supplementary Note 8

The measure planning support apparatus according to any one of supplementary notes 1 to 7, in which the priority indicates at least one of effectiveness of the measure on the user facility and fitness of the measure to the user facility.

### Supplementary Note 9

The measure planning support apparatus according to any one of supplementary notes 1 to 8, in which the priority determination unit presents at least a part of the acquired one or more measures and the priority determined for each measure to a user.

### Supplementary Note 10

A measure planning support method including
acquiring one or more measures that can be introduced into a user facility, and
determining priority of the one or more measures based on at least a part of facility information that is information regarding the user facility, case information regarding introduction results of past measures, and public information.

### Supplementary Note 11

A program for causing a computer to execute processing of
acquiring one or more measures that can be introduced into a user facility, and
determining priority of the one or more measures based on at least a part of facility information that is information regarding the user facility, case information regarding introduction results of past measures, and public information.

Some or all of the elements (e.g., configurations and functions) described in Supplementary Notes 2 to 9 dependent on Supplementary Note 1 may also depend on Supplementary Notes 10 and 11 by the dependency relationships similar to those of Supplementary Notes 2 to 9. Some or all of the elements described in any Supplementary Note may be applied to various types of hardware, software, recording means for recording software, systems, and methods.

1. A measure planning support apparatus comprising:
at least one memory storing instructions; and
at least one processor configured to execute the instructions to:
acquire one or more measures that can be introduced into a user facility; and
determine priority of the one or more measures based on at least a part of facility information that is information regarding the user facility, case information regarding introduction results of past measures, or public information.

2. The measure planning support apparatus according to claim 1, wherein the at least one processor is configured to execute the instructions to acquire a measure for at least partially solving a problem in the user facility as the one or more measures.

3. The measure planning support apparatus according to claim 1, wherein the at least one processor is configured to execute the instructions to extract the introduction results in a facility similar to the user facility from the case information based on the facility information, and determine the priority of the one or more measures based on the extracted introduction results.

4. The measure planning support apparatus according to claim 1, wherein the at least one processor is configured to execute the instructions to compare and analyze the facility information and information of a facility into which measures have been introduced in the past in the case information, and determine the priority of the one or more measures based on a result of the comparison and analysis.

5. The measure planning support apparatus according to claim 1, wherein the facility information includes information regarding a scale, an available product, a geographical condition, and an introduced system of the user facility.

6. The measure planning support apparatus according to claim 1, wherein the at least one processor is configured to execute the instructions to determine the priority of the one or more measures based on at least one of cost effectiveness in a case where the measure is introduced into the user facility, a period required to introduce the measure, suitability of the measure to the user facility, a geographical condition of the user facility, a risk of natural disaster, a goal in the user facility, or a state of an employee in the user facility.

7. The measure planning support apparatus according to claim 1, wherein the case information includes a successful case and a failure case.

8. The measure planning support apparatus according to claim 1, wherein the priority indicates at least one of effectiveness of the measure on the user facility or fitness of the measure to the user facility.

9. The measure planning support apparatus according to claim 1, wherein the at least one processor is configured to execute the instructions to present at least a part of the acquired one or more measures and the priority determined for each measure to a user.

10. A measure planning support method comprising:
acquiring one or more measures that can be introduced into a user facility; and
determining priority of the one or more measures based on at least a part of facility information that is information regarding the user facility, case information regarding introduction results of past measures, and public information.

11. A non-transitory computer-readable medium stored with a program for causing a computer to execute processing of:
acquiring one or more measures that can be introduced into a user facility; and
determining priority of the one or more measures based on at least a part of facility information that is information regarding the user facility, case information regarding introduction results of past measures, and public information.
